(19) United States
(12) Patent Application Publication
(10) Pub. No.: US 2022/0022441 A1
(43) Pub. Date: Jan. 27, 2022

(54) FLYING INSECT TRAP WITH ENHANCED ILLUMINATION

(71) Applicant: AP&G Co., Inc., Brooklyn, NY (US)

(72) Inventor: Edward William Dolshun, Warwick, NY (US)

(21) Appl. No.: 17/385,488

(22) Filed: Jul. 26, 2021

Related U.S. Application Data
(60) Provisional application No. 63/056,291, filed on Jul. 24, 2020.

(51) Int. Cl. A01M 1/08; A01M 1/10

(52) U.S. Cl. CPC A01M 1/08; A01M 1/106

(57) ABSTRACT

A flying insect trap formed of an ingress chamber having a light source to attract flying insects and a fan to create an air stream to direct insects into a capture chamber. The trap has an upper illumination chamber to project light upward in order to enhance the trap's attractiveness to flying insects. The upper illumination chamber is formed of a plate containing light emitting devices that face upward and project light through a translucent cover.

### RELATED APPLICATIONS

This application claims the benefit of pending U.S. Prov. Appl. 63/056,291 filed Jul. 24, 2020, the contents of which are incorporated by reference.

### FIELD OF THE INVENTION

The invention relates to the field of insect traps, more specifically to a flying insect trap having enhance illumination qualities for improved attractiveness to flying insects.

### BACKGROUND OF THE INVENTION

Various devices have been developed which seek to trap flying insects. One such device, known in the prior art, uses a fan mechanism to create an air current such that any insect that approaches the trap will be vacuumed into it. Generally, such traps have a sticky glue board or a mesh bag so that the insects remain trapped therein.

Existing devices may use an additional, non-chemical, attractant, such as a blue light source. However, traps that use such light sources as an attractant only illuminate the opening of the trap. Without additional illumination, the light source may not be as effective as other attractants or devices in luring insects to the trap—especially with respect to insects flying above the trap.

### SUMMARY OF THE INVENTION

Embodiments of the invention set forth herein are directed to a flying insect trap with enhanced illumination to increase the effectiveness of the trap, resulting in larger amounts of insects attracted and trapped in the device.

The device is formed of a capture chamber and a top portion. The invention provides an upper illumination chamber that having a cover positioned on the top portion thereof. The upper illumination chamber houses a light source which serves as an attractant to above-flying insects. The cover is made of a translucent material to provide greater illumination of the trap, thus attracting more insects.

Embodiments of the invention provide a trap having an ingress chamber comprising series of support members surrounding defining an inner chamber, a lower surface comprising a series of openings, an upper surface being substantially parallel to the lower surface, and a light emitting device projecting from the upper surface into the chamber define by the support members;

a fan disposed below the lower surface, the fan being housed by a fan housing;

a capture chamber disposed below the fan being detachably connected to the fan housing;

an intermediate plate provided above and substantially parallel to the upper surface of the ingress chamber, the intermediate plate having an upper surface and an underside surface;

one or more light emitting devices provided on the upper surface of the intermediate plate; and

a translucent cover disposed above the intermediate plate, whereby light projected from the light emitting devices provided on the upper surface of the intermediate plate passes through the translucent cover.

In embodiments of the invention, an illumination chamber is formed by the space between the intermediate plate (having LEDs mounted thereto) and a cavity formed by the cover.

Other principal features and advantages of the invention will become apparent to those skilled in the art upon review of the following drawings and detailed description.

### BRIEF DESCRIPTION OF THE DRAWINGS

Illustrative embodiments of the invention will hereafter be described with reference to the accompanying drawings, wherein like numerals denote like elements.

FIG. 1 is a perspective view of a trap known in the prior art for trapping flying insects.

FIG. 2 is a perspective view of a trap in accordance with embodiments of the invention.

FIG. 3 is a side view of a trap in accordance with embodiments of the invention.

FIG. 4 is an exploded view of a trap according to an exemplary embodiment of the invention.

FIG. 5 is a top cross-sectional view of a trap in accordance with an exemplary embodiment of the invention.

### DETAILED DESCRIPTION OF THE INVENTION

Embodiments of the present invention will now be described with reference to the above-identified Drawings. It will be understood that various modifications of the present description are possible without departing from the spirit of the invention. Also, features described herein may be omitted, additional features may be included, and/or features described herein may be combined in a manner different from the specific combinations recited herein, all without departing from the spirit of the invention.

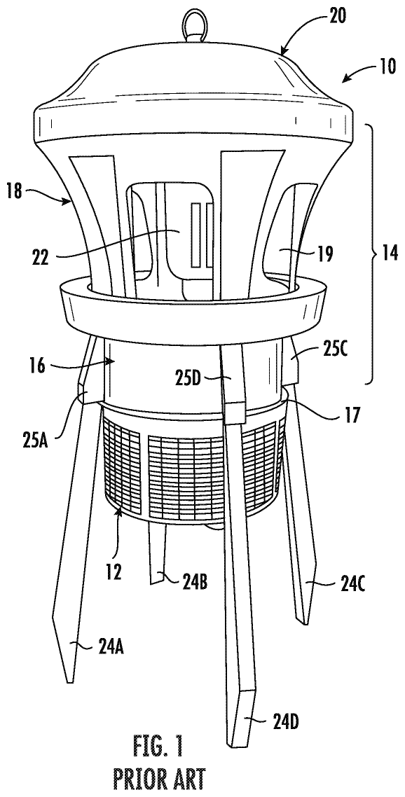

FIG. 1 shows a perspective view of a trap 10, which is traditionally used in prior art to trap flying insects.

As shown, trap 10 is comprised of a capture chamber 12 and upper housing 14. Chamber 12 generally includes a glue trap or mesh bag to trap insects therein.

Upper housing 14 is comprised of a lower portion which is a fan housing segment 16, ingress chamber 18, and cover 20. The fan-housing segment 16 includes a fan mechanism to produce an air current designed to pull insects caught in the air flow into the device.

Chamber 12 is secured to fan-housing segment 16 along the inner circumference of chamber 12 at surface 17. It will be understood that any of various temporary securement mechanisms may be used to temporarily secure chamber 12 to fan-housing segment 16 of housing 14 in different embodiments of the invention.

The ingress chamber 18 of upper housing 14 includes openings, such as opening 19, to permit insects to enter the vicinity of the airflow produced by the fan. In embodiments of the invention, ingress chamber 18 forms an ingress portion having a light source (e.g. light bulb 22) provided substantially in the center thereof as an attractant for insects. Insects enter the ingress portion through any of a series of openings 19.

Ingress chamber 18 of housing 14 has a cover 20 provided atop thereof. In embodiments of the t invention, cover 20 is made of a translucent material and houses a separate light source.

Trap 10 may also include legs 24A-D to support and elevate trap 10 off of the ground. Legs may be secured onto lower portion 16 of housing 14 by holders 25A-D (25B not shown), respectively. It will be understood that any of various temporary securement mechanisms may be used to temporarily secure the legs to their respective holders in different embodiments of the invention.

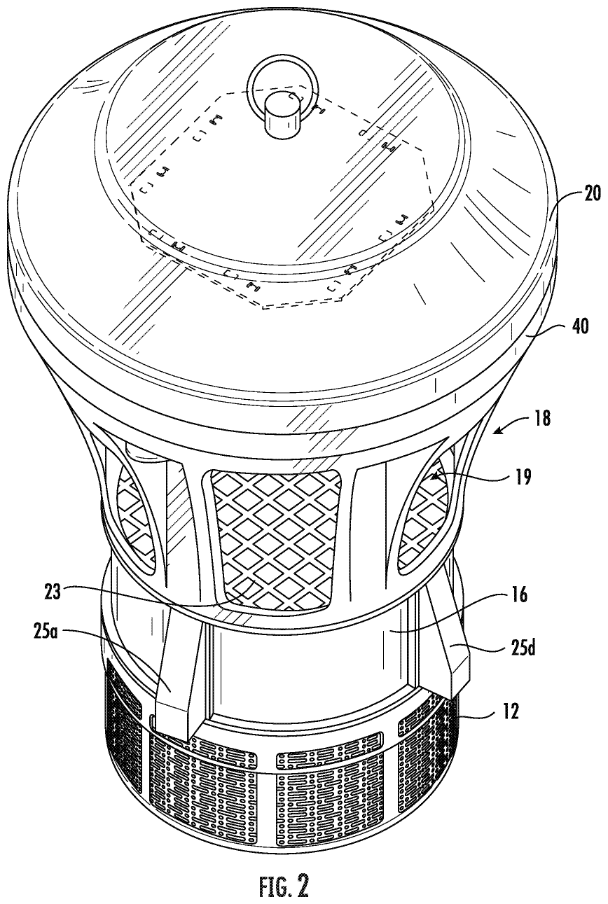

FIG. 2 shows a top perspective view of a trap 10 in accordance with an embodiment of the invention. As shown, ingress chamber 18 of upper housing 14 is formed of series of spaced apart support members 21 which surround an longitudinal axis of the trap 10 to form an inner chamber. The respective support members 21 are spaced apart from each other in order to define a of openings to allow the ingress of flying insects into the inner chamber. A lower surface of ingress chamber 18 is formed of a slotted floor 23. Slotted floor 23 contains a series of openings or vents to allow the passage of insects. In embodiments of the invention a downward facing fan is disposed below the slotted floor 23 to create a downward moving air stream to direct insects into the capture chamber 12.

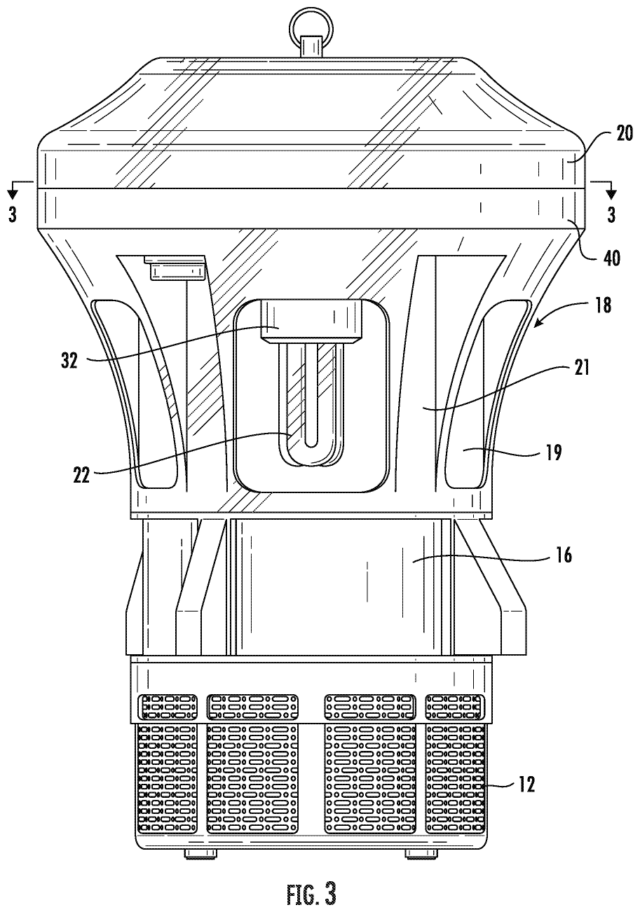

FIG. 3 shows a side view of a trap 10 in accordance with an embodiment of the invention. As shown, a cover 20 is secured to the top of the ingress chamber. In embodiments of the invention, cover 20 has a lower enclosure and sloping upper walls. In embodiments, a cavity is formed within the inside of cover 20.

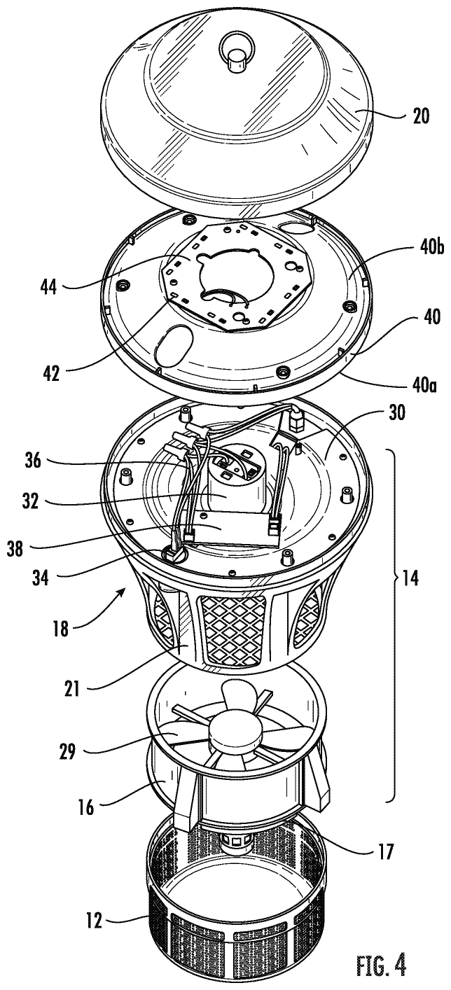

FIG. 4 shows an exploded view of the trap 10 in accordance with an embodiment of the invention. As shown, the lower segment unit is provided with a capture chamber 12. A lower end of lower portion of upper housing 14 engages with capture chamber 12. In embodiments of the invention, capture chamber 12 is threadedly connected to lower end of housing portion 16. As shown, a downward facing fan 29 is disposed within fan-housing chamber 16 and positioned above (or partially within) the capture chamber 12. As shown, slotted floor 23 of ingress chamber 18 is connected to a top section of fan-housing segment.

In embodiments of the invention, and as shown, ingress chamber 18 is provided with a top panel 30. Top panel 30 supports a downward-facing bulb socket 32 disposed in the general center of top panel 30. As shown, in embodiments of the invention, a cutout 34 in top panel 30 is provided to allow the passages of wires 36 from a power cord to the light emitting devices (a separate wire is directed to the fan 29).

In embodiments of the invention, one or more wires 36 are directed to a circuit board 38. In embodiments of the invention, circuit board 38 includes a transformer for transforming current delivered to one or more of the light-emitting devices. In embodiments of the invention, a pair of wires is connected to the light bulb socket 32 and another pair of wire is directed upward to power one or more LEDs as described in more detail below.

With continued reference to FIG. 4, in embodiments of the invention, an intermediate plate 40 is provided between the top panel 30 of ingress chamber 18 and the cover 20. As shown, intermediate plate 40 has an underside surface 40a that is connected to the upper surface of ingress chamber 18 and an upper surface 40b that is configured for securing cover 20. Intermediate plate 40 is positioned to be substantially parallel to, and sandwiched between, an upper surface of top panel 30 of ingress chamber 18 and cover 20. In embodiments of the invention, a rounded outer perimeter surface is of intermediate plate 40 is substantially sized to be the same shape and size as the perimeter of an upper aspect of ingress chamber 18 and the same shape and size as a lower aspect of a perimeter surface of cover 20. For example, as shown, a collar rising above top panel forms an upper aspect of the ingress chamber. In this regard, the respective outer perimeter surfaces of an upper aspect of ingress chamber 18, intermediate plate 40 and a lower portion of cover 20 form a substantially contiguous outer perimeter surface (as best shown in FIG. 3).

In embodiments of the invention, the intermediate plate 40 and cover 20 are fasted with one or more screws to the top panel 30 of ingress chamber 18—but any of securement means such as glue, snaps, or similar mechanisms may be utilized in embodiments of the invention.

As shown, upper surface 40b of intermediate plate 40 is provided with one or more LEDs 42 or similar light-emitting devices. In embodiments of the invention, a panel 44 containing surface mounted LEDs is attached to upper surface 40b of intermediate plate 40. LEDs 42 or similar light emitting devices are provided on the surface of upper surface 40b of intermediate plate 40 and direct light upwardly toward the inside of the cover 20. LEDs are of sufficient illuminance to allow light emitted therefrom to pass through the translucent cover 20—thereby projecting light upward from the trap 10. In this regard, light emitted by LEDs 42 are visible to insects flying above the trap, which increases the attractability and reach of the trap 10.

It will be understood that LEDs 42 may powered by wires emanating from circuit board 38, and in embodiments of the invention, converted by a transformer provided on the circuit board 38.

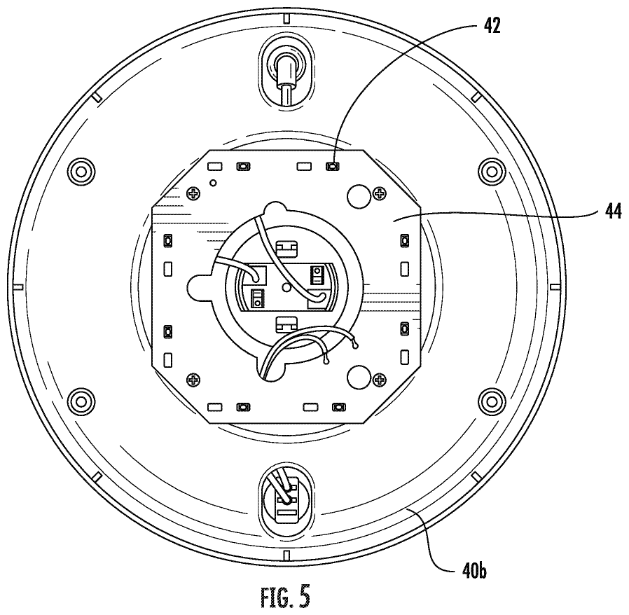

FIG. 5 shows a cross-sectional view as defined by lines 3-3 in FIG. 3. As shown, a panel 44 secured to upper surface 40b of intermediate plate 40 carries one or LEDs facing upwardly toward the inside of the cover 20.

In an exemplary set up of the trap, a user screws chamber 12 to a lower aspect of upper housing 14. In embodiments, chamber 12 is threadedly engages the fan-housing segment 16 such that the user rotates chamber 12 with respect to upper housing 14 such that inner circumference of chamber 12 engages at threaded surface 17. Legs 24A-D are thereafter attached to their respective holders 25A-D. The user then activates light bulb 22 and 42, and the fan in lower portion 16. In embodiments of the invention, a single switch is utilized to power the light bulb 22, LEDs 42 and the fan 29. When trap 10 is placed, lights 22 and 42 attract flying insects to trap 10. Insects enter the vicinity of the airflow produced by the fan through openings, in slotted floor 23, and are vacuumed into chamber 12. In embodiments of the invention, the interior of chamber 12 may contain a glue board or a mesh bag such that once inside chamber 12, insects are trapped by means of the sticky glue board, or become trapped within a mesh bag.

Having described the subject matter of the application with regard to specific embodiments, it is to be understood that the description is not meant as a limitation since further modifications and variations may be apparent or may suggest themselves to those skilled in the art. It is intended that the present application cover all such modifications and variations.

What is claimed is:

1) A flying insect trap, comprising:
an ingress chamber comprising series of support members surrounding defining an inner chamber, a lower surface comprising a series of openings, an upper surface being substantially parallel to the lower surface, and a light emitting device projecting from the upper surface into the chamber define by the support members;
a fan disposed below the lower surface, the fan being housed by a fan housing;
a capture chamber disposed below the fan being detachably connected to the fan housing;
an intermediate plate provided above and substantially parallel to the upper surface of the ingress chamber, the intermediate plate having an upper surface and an underside surface;
one or more light emitting devices provided on the upper surface of the intermediate plate; and
a translucent cover disposed above the intermediate plate, whereby light projected from the one or more light emitting devices provided on the upper surface of the intermediate plate passes through the translucent cover.

2) The flying insect trap of claim 1, whereby the one or more light emitting devices comprise one or more LEDs.

3) The flying insect trap of claim 2, whereby the one or more LEDs are mounted on a panel attached to the upper surface of the intermediate plate.

4) The flying insect trap of claim 1, whereby the cover defines a cavity.

5) The flying insect trap whereby the upper surface of the intermediate plate and cavity of the cover comprises an illumination chamber.
